(19) United States
(12) Patent Application Publication
(10) Pub. No.: US 2010/0044997 A1
(43) Pub. Date: Feb. 25, 2010

(54) FIFTH WHEEL HITCH CART ASSEMBLY

(76) Inventors: David J. Burns, Draper, UT (US); Erik M. Mumford, Sandy, UT (US)

Correspondence Address: Kunzler & McKenzie, 8 EAST BROADWAY, SUITE 600, SALT LAKE CITY, UT, 84111, US

(21) Appl. No.: 12/605,915

(22) Filed: Oct. 26, 2009

Related U.S. Application Data
(63) Continuation-in-part of application No. 11/933,940, filed on Nov. 1, 2007, now abandoned.

(51) Int. Cl. B62D 53/08

(52) U.S. Cl. 280/434; 280/433

(57) ABSTRACT

A fifth wheel hitch cart is used for positioning a hitch in a truck bed. The cart is provided with a plate and a pivoting arm disposed between a rolling device and the plate. At least one handle is coupled with the plate. A plurality of cams are operably coupled with the at least one handle and disposed between the plate and the pivoting arm such that rotational movement of the handle causes the cams to lift the plate.

### CROSS-REFERENCE TO RELATED APPLICATION

The present application is a continuation-in-part of U.S. patent application Ser. No. 11/933,940, filed Nov. 1, 2007, which is incorporated herein by reference.

### FIELD

The present invention relates generally to towing devices and, more particularly, to a fifth wheel hitch cart.

### BACKGROUND

Fifth wheel hitches have been used for decades to tow a trailer behind a vehicle. Conventional fifth wheel hitches typically include a support frame for mounting the hitch to the towing vehicle, such as, for example, to a bed of a pickup truck and a head assembly which includes the mechanism for attaching the hitch assembly to a king pin of the fifth wheel trailer.

The support frame or conventional fifth wheel hitches often includes a pair of base rails that are bolted to the bed and or frame of the truck, side brackets that are releasably mounted to the base rails and a head support mounted to the side brackets. The head assembly is mounted to the head support by means of a trunnion arrangement allowing for pivotal fore-and-aft movement relative to the side brackets.

For fifth wheel hitches designed to couple to a king pin-type fifth wheel, the head assembly includes a jaw assembly operable by means of a control handle. The jaw assembly is specifically adapted to releasably engage and hold the kingpin of the trailer.

Conventional fifth wheel trailer hitches are typically centered over the axles of the rear wheels of the towing vehicle so as to place the tongue-weight of the vehicle over the rear tires. This results in a desired weight positioning of the trailer relative to the towing vehicle for traveling at highway speeds.

Currently, fifth wheel hitches mount to a set of bedrails in the bed of the towing vehicle. Tabs extending downward from the hitch engage openings in the bedrails. In order to prevent movement of the fifth wheel hitch under a load, the openings in the bedrails must tightly engage the tabs of the hitch. One drawback to this is that the fifth wheel hitch must be “dropped” or lowered such that all tabs engage the bedrails simultaneously. If the bedrails are not engaged simultaneously the fifth wheel hitch will bind and not install correctly.

Unfortunately, current fifth wheel hitches are often very heavy and difficult to remove/install. Proper installation often requires that a person lower the hitch, which may weigh more than 100 pounds, in an awkward position. One person installations/removals require a strong back.

What is needed is an apparatus for easy removal of a fifth wheel hitch that allows one-person installation/removal. Furthermore, the apparatus must properly raise/lower the fifth wheel hitch such that the tabs engage the bedrails simultaneously.

### SUMMARY

A fifth wheel hitch cart is used for positioning a hitch in a truck bed. The cart is provided with a plate and a pivoting arm disposed between a rolling device and the plate. At least one handle is coupled with the plate. A plurality of cams are operably coupled with the at least one handle and disposed between the plate and the pivoting arm such that rotational movement of the handle causes the cams to lift the plate.

The fifth wheel hitch cart allows easy one-person installation/removal of a fifth wheel hitch. Additionally, the invention allows a user to properly raise/lower the fifth wheel hitch such that the tabs engage the bedrails simultaneously.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating a truck and trailer utilizing a fifth wheel hitch in accordance with the prior art;

FIG. 2 is a perspective view illustrating a fifth wheel hitch in accordance with the prior art;

FIG. 3 is a side view diagram illustrating one embodiment of a side bracket in accordance with the prior art;

FIG. 4 is a perspective view diagram illustrating a fifth wheel hitch cart assembly in accordance with the present invention;

FIG. 5 is a side view diagram illustrating one embodiment of a fifth wheel cart in accordance with the present invention;

FIG. 6a is a perspective view diagram illustrating another embodiment of a fifth wheel cart in accordance with the present invention;

FIG. 6b is a perspective view diagram illustrating one embodiment of the handle in accordance with the present invention;

FIG. 7a is a side view diagram illustrating one embodiment of a fifth wheel cart in a “ready-to-lift” position in accordance with the present invention;

FIG. 7b is a side view diagram illustrating one embodiment of a fifth wheel cart in a “lifted” position in accordance with the present invention;

FIGS. 8a, 8b, and 8c are front view diagrams illustrating one embodiment of a cam in accordance with the present invention;

FIG. 9 is a side view diagram illustrating another embodiment of a fifth wheel cart in a “lifted” position in accordance with the present invention;

FIG. 10 is a schematic flow chart diagram illustrating one embodiment of a method for simultaneously engaging tabs and bedrails in accordance with the present invention; and

FIG. 11 is a schematic block diagram illustrating one embodiment of an alternative lifting mechanism in accordance with the present invention;

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

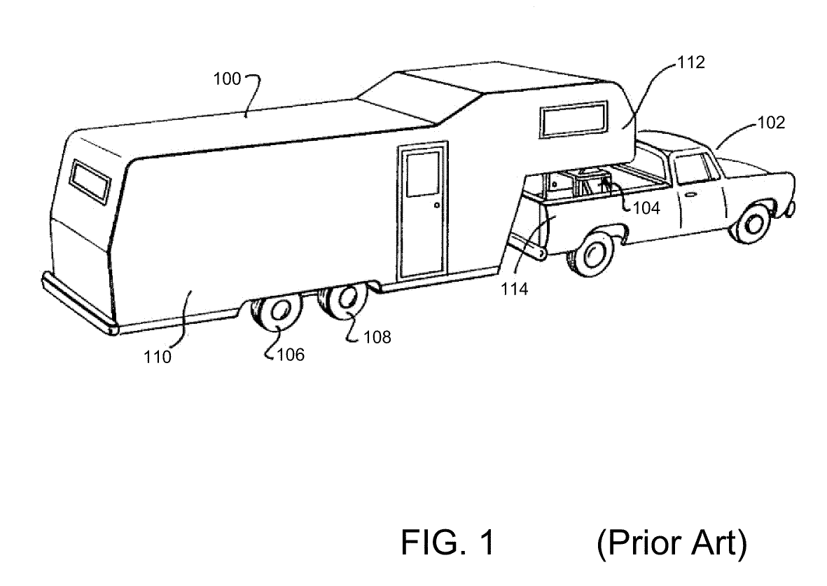

FIG. 1 is a perspective view diagram illustrating a fifth wheel trailer 100 connected to a pickup truck 102 using a fifth wheel hitch (hereinafter “hitch”) 104 in accordance with the prior art. Fifth wheel trailers 100 may include one or more axles, and in the depicted embodiment, include tandem axles having front and rear wheels 106, 108. The wheels 106, 108 together with the axles support a body 110 having a forward portion 112 that projects over a bed 114 of the truck.

The forward portion 112 generally includes a downwardly projecting support system that connects to the hitch 104 of the truck 102. The support system generally comprises a cylinder referred to as a “kingpin” that engages a jaw mechanism of the hitch 104. The kingpin must engage the jaw mechanism of prior art hitches in such a way as to create a secure connection.

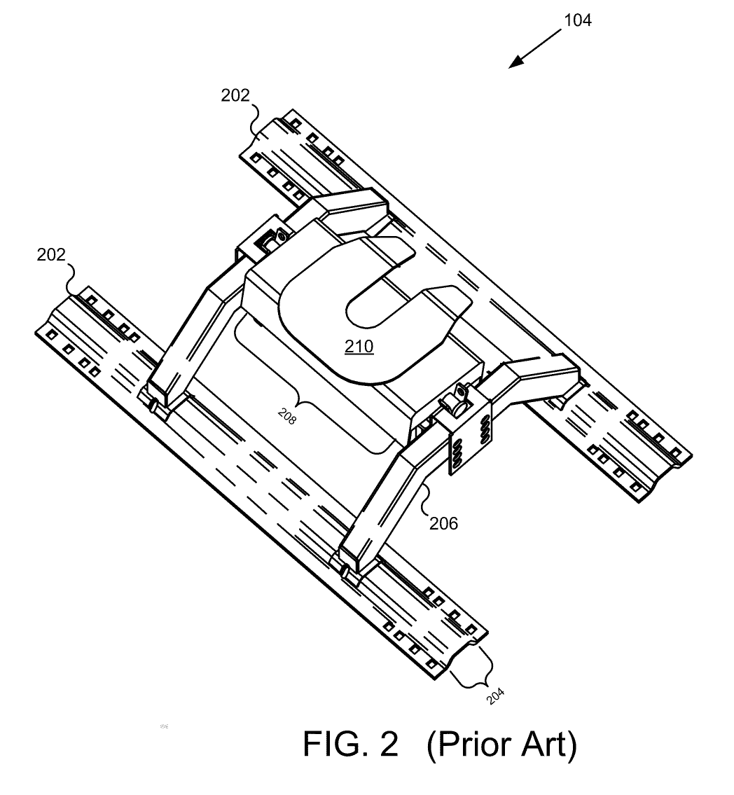

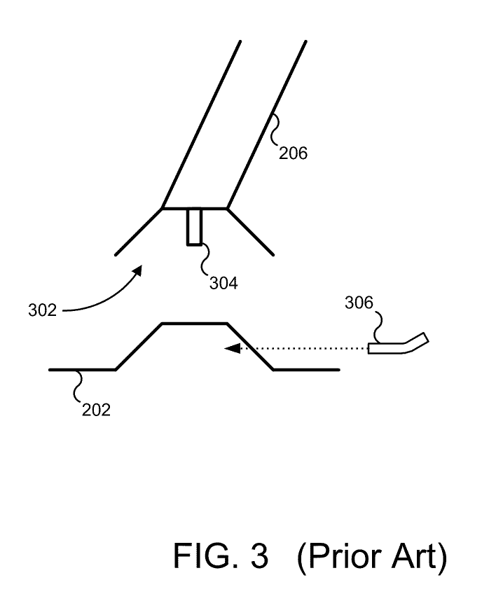

FIG. 2 is a perspective view drawing illustrating one embodiment of a hitch 104 connected with a plurality of bedrails 202 in accordance with the prior art. The bedrails 202 may comprise elongated support members having a longitudinal channel. The longitudinal channel 204, in one embodiment, is formed with a geometric shape configured to engage side brackets 206 of the hitch 104. A similar geometric shape may be formed in the bedrail engaging portions of the side bracket 206 (See FIG. 3). Bedrails 202 are commonly installed in the beds of towing vehicles such as trucks.

The hitch 104 generally includes a plurality of side brackets 206, a head support disposed between the side brackets, and a head 208 connected with the head support. The head comprises a cover plate 210 that covers the internal jaw mechanism (not shown) that connects to the kingpin of the trailer 100. The components and structure of hitches 104 are well known to those skilled in the art and further discussion will not be given herein.

FIG. 3 is a side view diagram illustrating one embodiment of a side bracket 206 in accordance with the prior art. In one embodiment, the side bracket 206 is formed having a downwardly facing brace 302 for engaging an upwardly facing surface of the bedrail 202. The brace 302, as described above, may be formed having a configuration similar to that of the channel 204 of the bedrail 202.

In a further embodiment, the side bracket 206 is coupled with a tab 304. The tab 304 extends downward from the side bracket 206 and is insertable into a slot in the bed rail 202. The tab 304 is configured with an opening for receiving a pin 306. The pin 306 secures the side bracket 206 and subsequently the entire hitch assembly 104.

In order to prevent movement of the hitch 104 under load, the slot in the bedrail must not be much larger than the tab 304. The tightness of the tab/slot interface requires that the tabs 304 of each side bracket 206 (typically 4 tabs, See FIG. 2) of the hitch 104 simultaneously engage the bedrails 202 in order to prevent binding.

The bedrails 202 of the depicted embodiment are generally installed over the bed of a towing vehicle. However, many different bedrails exist that are not depicted herein, but are functional with the present invention. For example, different shaped channels may be formed in the bedrail, including, but not limited to square, rectangular, and oval shaped channels. The bedrails may be installed under the bed of the towing vehicle. Furthermore, the side brackets may not comprise downward facing brackets for engaging the bedrail.

The tab may be replaced with different shaped protrusions and the slot with a corresponding opening for receiving the protrusion. Alternatively, the tab may extend upward from the bedrail and be received by a slot in the side bracket. In other words, the present invention may be utilized in many different side bracket/bedrail configurations. It is contemplated that the present invention may be applied to any bedrail/side bracket configuration that requires a substantially horizontal load/remove procedure.

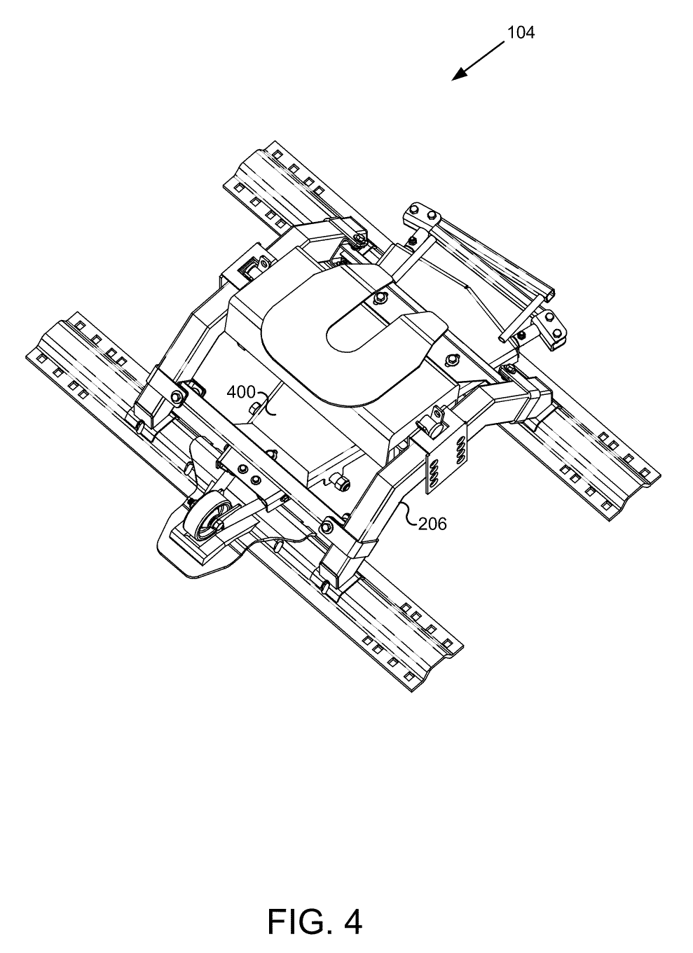

FIG. 4 is a perspective view diagram illustrating a fifth wheel hitch cart assembly 400 in accordance with the present invention. The fifth wheel hitch cart enables a user to properly load or remove a hitch 104 by himself or herself. In other terms, the cart 400 enables a user to simultaneously engage the tabs 304 of each side bracket 206. As depicted, the cart 400 may be coupled with the side bracket 206 in order to move the hitch 104 in a manner similar to a wheelbarrow.

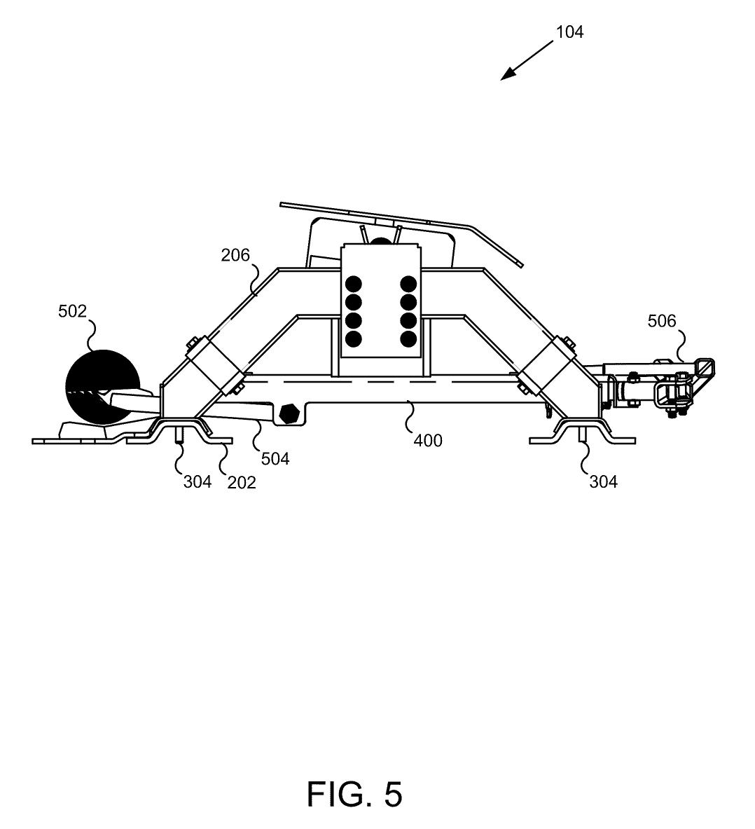

FIG. 5 is a side view diagram illustrating one embodiment of the cart 400 in accordance with the present invention. In the depicted embodiment, the cart 400 lies flat in a “stowed” position. As illustrated, the tabs 304 are fully seated in the bedrails 202 and are ready to be secured by pins or other fastening devices. The cart 400 includes at least one wheel 502 connected with a pivoting arm 504. The cart also includes a plurality of handles 506. The structure and function of the cart 400 will be described in greater detail below.

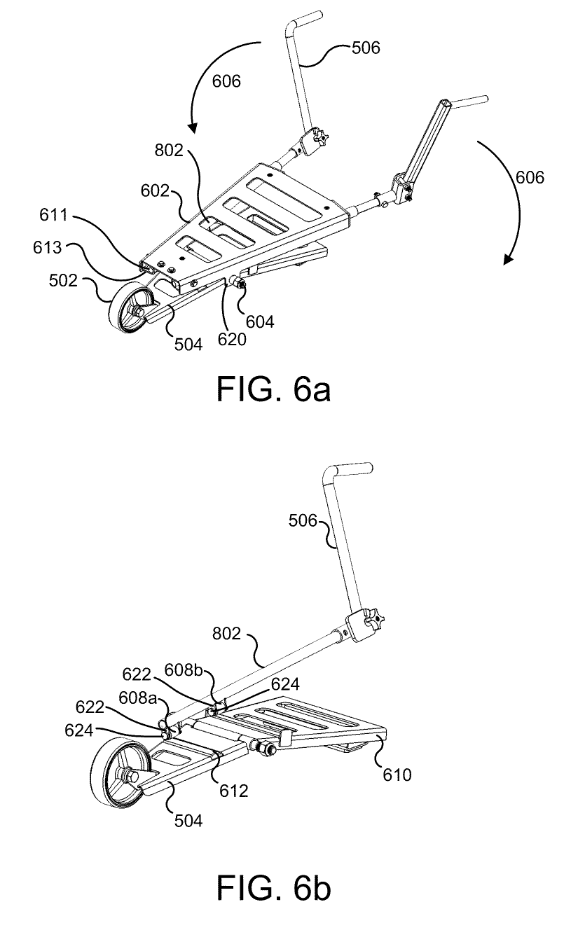

FIG. 6a is a perspective view diagram illustrating another embodiment of the cart 400 in accordance with the present invention. In one embodiment, the cart 400 includes the wheel 502, the handles 506, and a plate 602 disposed there between. Coupling the wheel 502 to the plate 602 is the pivoting arm 504 which may pivot about an axis defined by a pivot arm attachment point 604. The plate 602 includes an attachment tab 620 through which the pivot arm attachment point 604 extends such that as the pivoting arm 504 pivots about the pivot arm attachment point, the pivoting arm pivots either toward or away from the plate. The wheel 502 may be replaced with any rolling device including, but not limited to, a ball, a rolling pin, etc.

The handles 506 support the plate 602 and also rotate within collars (not shown) coupled to the plate 602. The handles 506 may rotate outward and downward in a direction generally indicated by arrows 606. Furthermore, the handles 506 are collapsible when the cart 400 is in a “stowed” configuration.

FIG. 6b is a perspective view diagram illustrating one embodiment of the handle 506 in accordance with the present invention. Various components of FIG. 6a have been omitted in FIG. 6b for clarity. In particular, the plate 602 is not shown in FIG. 6b. In the depicted embodiment, the handle 506 comprises a plurality of cams 608 (e.g., cams 608a, 608b) coupled with the handle 506. The cams 608, in one embodiment, may comprise casters, wheels, or alternatively a slidable material such as a wear-resistant plastic. In the illustrated embodiment, the cams 608a, 608b are coupled to one or more lever arms 622 secured to a shaft 802. The lever arms 622 are secured to the shaft 802 at a first end and the cams 608a, 608b at a second end opposite the first end. Pin 624 extending through the lever arms 622 can act as a pivot axis to secure the cams 608a, 608b to the lever arms 622. The cams 608a, 608b are rotatable about the pins 624.

The cart 400 may comprise a second pivoting arm 610 (hereinafter “rear arm 610”). As depicted, each handle 506 comprises two cams 608, each cam engaging a pivoting arm. As used herein, the term “cam” refers to a device that is configured to convert circular motion into linear motion. In the depicted embodiment, the cams 608 convert the circular rotation of the handles 506 into a linear lifting or lowering motion of the plate 602 which subsequently raises or lowers the hitch 104. For example, as the handles 506 rotate, the cams 608a, 608b also rotate and move, e.g., roll, along the pivoting arms 504, 610, respectively. Additionally, as the handles 506 rotate between two directions, the lever arms 622 correspondingly rotate toward and away from the respective pivoting arms 504, 610. As the lever arms 622 rotate toward the pivoting arms 504, 610 the cams 608a, 608b roll in a first direction along the respective pivoting arms 504. Because the plate 602 and pivoting arms 504, 610 are pivotally coupled to each other at the pivot point 604, the cams 608a, 608b rolling in the first direction cause the distance between the plate 602 (to which the shaft 802, and thus the lever arms 622 and cams 608a, 608b are secured) and the pivoting arms 504, 610 to increase, which effectively raises the plate relative to the pivoting arms. Similarly, as the lever arms 622 rotate away the pivoting arms 504, the cams 608a, 608b roll in a second direction opposite the first direction along the respective pivoting arms 504. The cams 608a, 608b rolling in the second direction allow the distance between the plate 602 and the pivoting arms 504 to decrease, which effectively lowers the plate relative to the pivoting arms.

In one embodiment, the cart 400 may be configured without a rear arm 610 (See FIG. 5). For example, instead of a cam 608 pressing downward on the rear arm 610, the rear cam 608b may be positioned above a bedrail 202 such that as the cam generates a lifting force on the bedrail instead of the rear arm 610.

In a further embodiment, the pivoting arms 504, 610 may include paths 612 upon which the cams 608 may travel. As depicted, the paths 612 may comprise a raised portion formed on the surface of the pivoting arm 504, 610.

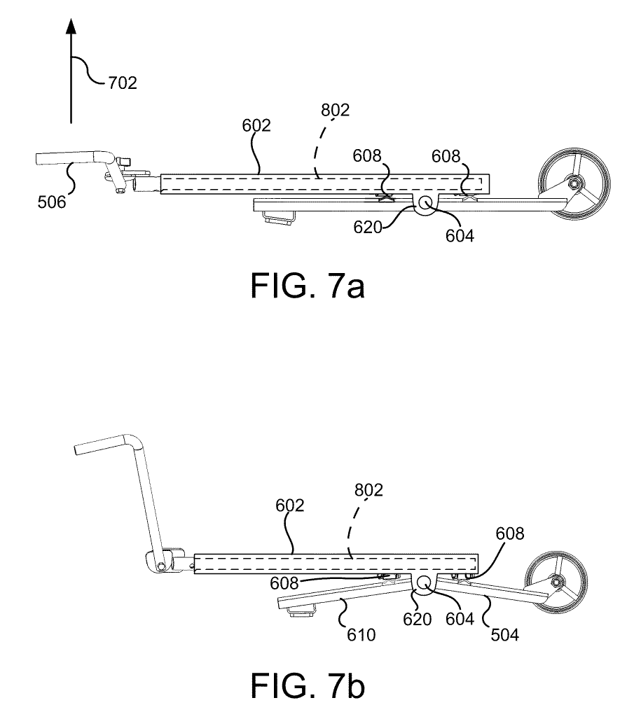

FIG. 7a is a side view diagram illustrating one embodiment of a cart 400 in a “ready-to-lift” position in accordance with the present invention. Like FIG. 6b, FIG. 7a has omitted several components for clarity but shows the plate 602 in solid lines and shaft 802 in hidden lines. In a “ready-to-lift” position the handles 506 are pivoted outward from a “stowed” position. The cams 608 are not providing a lifting force. Arrow 702 indicates the general direction of the movement of the handle as the cart goes from a “ready-to-lift” position to the “lifted” position of FIG. 7b. The handles 506 rotate inward and upward and subsequently the cams 608 push downward on the pivoting arms to create a lifting force on the hitch.

FIG. 7b is a side view diagram illustrating one embodiment of the cart 400 in a “lifted” position in accordance with the present invention. As the handles 506 are rotated upward and inward the cams 608 likewise rotate and subsequently push downward on the pivoting arms 504, 610. Because the pivoting arms 604, 610 are supported by the bed rails at their free ends (see FIG. 4), the downward movement of the cams 608 causes the pivoting arms to pivot about pivot point 604 (e.g., rotate away from the plate 602) to increase the distance between the pivoting arms and the plate. As the pivoting arms 604, 610 pivot away from the plate 602, the free ends of the pivoting arms 604, 610 move slightly toward each other, which is facilitated by the rolling of the wheel 502. One benefit of the present invention is the substantially parallel lifting force generated by the cams on the pivoting arms. In other terms, the cart 400 lifts the hitch 104 in such a manner that all four legs of the hitch 104 lift or lower simultaneously at a an equal rate. This prevents binding of the tabs in the bedrails.

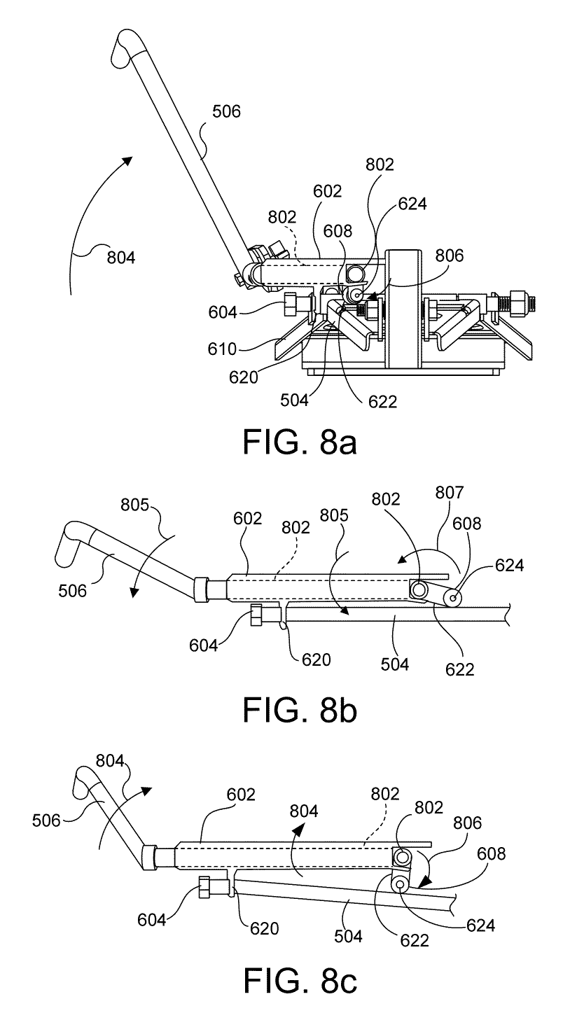

FIGS. 8a, 8b, and 8c are front view diagrams illustrating one embodiment of the cam 608 in accordance with the present invention. In one embodiment, a shaft 802 rotatably couples the handle 506 with the cam 608. The portion of the shaft 802 covered by the plate 602 is shown in hidden line for clarity in describing other aspects of the invention. The shaft 802 transfers the rotational movement of the handles 506 to the cam 608. FIG. 8b depicts a “lowered” position in which the hitch 104 would be lowered onto the bedrails. FIG. 8c depicts a “lifted” position in which the hitch 104 either has been lifted from the bedrails or is ready to be lowered onto the bedrails.

From the lowered position, as the handles are rotated upward (indicated by arrow 804), the cam moves downward (indicated by arrow 806) and the downward force on the pivoting arm 504 is applied (see FIG. 8c). The downward force on the pivoting arm 504 translates to the plate 602 being raised relative to the pivoting arm due to the pivot point 604 shared between the pivoting arm and plate. Similarly, from the lifted position, as the handles are rotated downward (indicated by arrow 805), the cam moves upward (indicated by arrow 807) and the downward force on the pivoting arm 504 is released (see FIG. 8b). The release of the downward force on the pivoting arm 504 allows the plate 602 to be lowered relative to the pivoting arm due to the shared pivot point 604. Consequently, the opposing upward force on the hitch 104 is also released and the hitch 104 is correspondingly lowered.

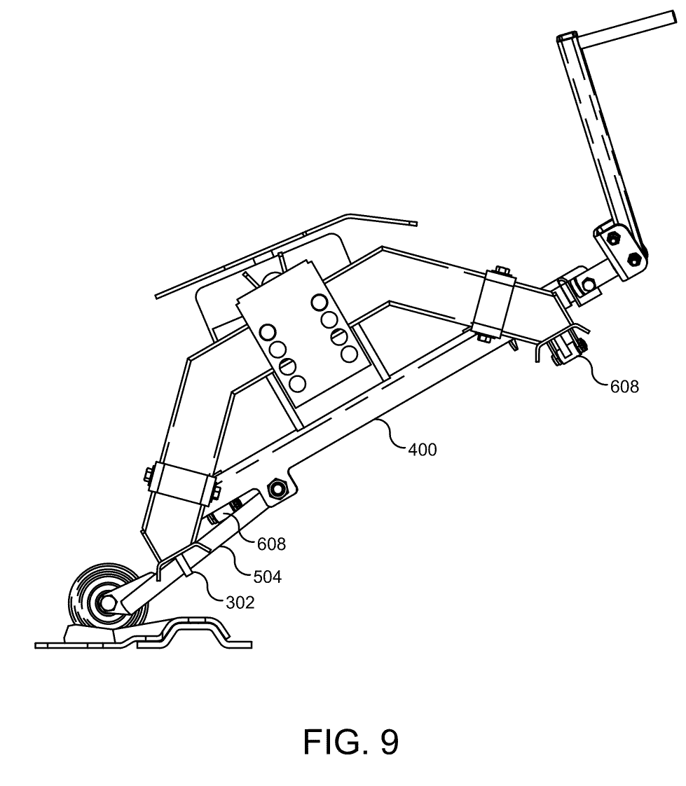

FIG. 9 is a side view diagram illustrating another embodiment of the cart 400 in accordance with the present invention. The depicted embodiment illustrates the cart 400 in a “lifted” position. Once the tabs 304 have cleared the bedrails 202, the entire apparatus (cart 400 and hitch 104) may be lifted and moved in a manner similar to a wheelbarrow. FIG. 9 illustrates a cart 400 having only a front pivoting arm 504, however, the cart 400 may be configured with the rear pivoting arm 610 of FIGS. 6a-7b.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

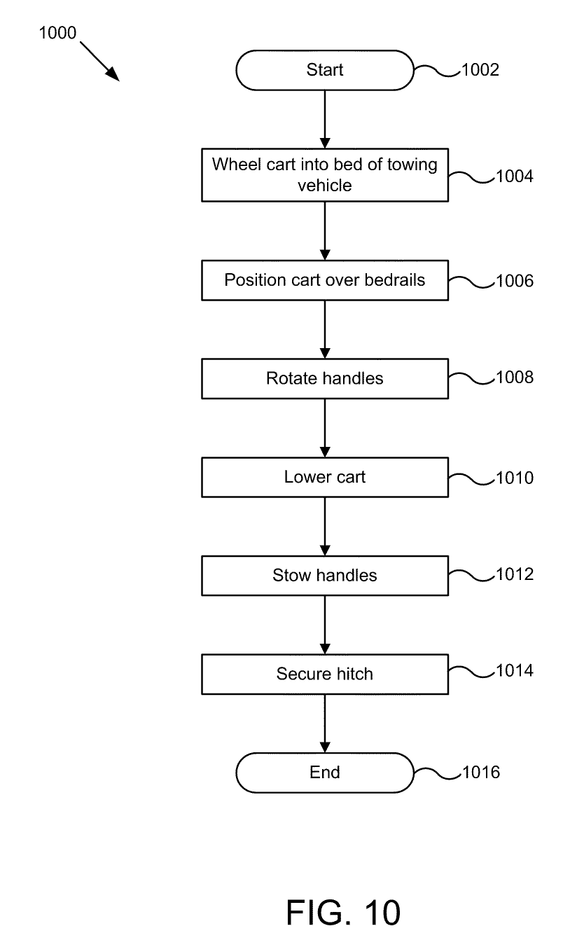

FIG. 10 is a schematic flow chart diagram illustrating one embodiment of a method 1000 for simultaneously engaging the tabs 304 and the bedrails 202 in accordance with the present invention. The method 1000 starts 1002 and the cart 400 and the hitch 104 are wheeled 1004 into the bed of a towing vehicle in a manner similar to a wheel barrow. A user then positions 1006 the cart over the bedrails 202 and the user rotates 1008 the handles downward, lowering 1010 the tabs 304 into the slots in the bedrails. The user may then pivot the handles inward, thereby stowing 1012 the handles. Upon securing 1014 the hitch by placing pins in the tabs, the method 1000 ends 1016.

Likewise, the hitch 104 may be removed or lifted by reversing the above described steps.

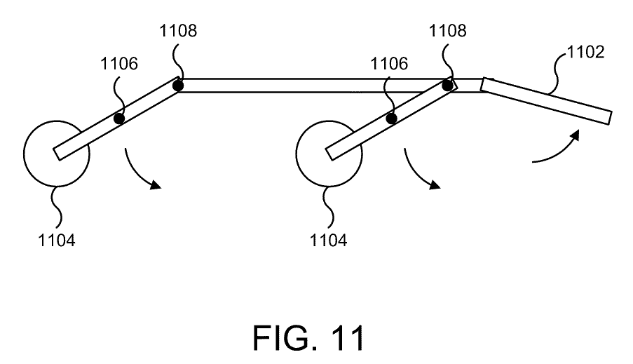

FIG. 11 is a schematic block diagram illustrating one embodiment of an alternative lifting mechanism in accordance with the present invention. In one embodiment, the rotating handles may be replaced with a linear system wherein vertical lift applied to the handles 1102 translates through a linkage system to simultaneously lower wheels 1104 at a substantially equivalent rate in order to lift the hitch without binding. Pivot points 1106, in one embodiment, are fixed or coupled to a side bracket. Pivot points 1108 may be free to move. Lifting up on the handle 1102 causes the wheels 1104 to move downward and provide a lifting force on the hitch assembly.

It is also contemplated that the manual lifting systems taught above may be replaced with mechanical, electrical, hydraulic, or pneumatic systems to provide a lifting force.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fifth wheel hitch cart assembly, comprising:
a plate;
a pivoting arm disposed between a rolling device and the plate;
at least one handle coupled with the plate; and
a plurality of cams operably coupled with the at least one handle and disposed between the plate and the pivoting arm such that rotational movement of the handle causes the cams to lift the plate.

2. The assembly of claim 1, wherein the pivoting arm is a first pivoting arm and the plurality of cams is a plurality of first cams, the assembly comprising a second pivoting arm pivotally coupled with the first pivoting arm and a plurality of second cams operably coupled with the at least one handle and disposed between the plate and the second pivoting arm such that rotational movement of the handle causes both the first and second cams to lift the plate.

3. The assembly of claim 1, wherein the at least one handle comprises first and second handles.

4. The assembly of claim 3, wherein rotational movement of the first handle in a first direction and rotational movement of the second handle in an opposite direction causes the cams to lift the plate.

5. The assembly of claim 1, wherein each of the plurality of cams comprises a wheel that rolls along the pivoting arm as the at least one handle is rotated.

6. The assembly of claim 1, wherein each of the plurality of cams comprises a lever arm secured to the at least one handle at one end and a wheel at the opposite end.

7. The assembly of claim 1, wherein the at least one handle is liftable to raise the plate and pivoting arm relative to the rolling device.

8. The assembly of claim 7, wherein as the plate and pivoting arm are raised relative to the rolling device, the plate and pivoting arm rotate about the rolling device.

9. The assembly of claim 1, wherein the at least one handle is pushable to rotate the rolling device in a first direction and move the fifth wheel hitch cart assembly in a forward direction, and pullable to rotate the rolling device in a second direction and move the fifth wheel hitch cart assembly in a backward direction.

10. The assembly of claim 1, wherein the at least one handle is collapsible from an in-use configuration into a stowed configuration.

11. The assembly of claim 1, wherein the fifth wheel hitch cart assembly is configured to fit between a fifth wheel hitch and bedrails when the fifth wheel hitch is secured to the bedrails.

12. The assembly of claim 11, wherein the fifth wheel hitch comprises a plurality of first engagement features each configured to matingly engage a respective one of a plurality of second engagement features formed in the bedrails, the first engagement features being engaged with the second engagement features when the hitch is secured to the bedrails, and wherein rotational movement of the handle causes the cams to vertically lift the plate and the hitch such that the first engagement features are simultaneously vertically lifted out of engagement with the second engagement features.

13. The assembly of claim 1, wherein rotational movement of the handle in a first direction causes the cams to lift the plate, and rotational movement of the handle in a second direction opposite the first direction causes the cams to lower the plate.

14. The assembly of claim 13, wherein the fifth wheel hitch cart assembly is configured to fit between a fifth wheel hitch and bedrails when the fifth wheel hitch is secured to the bedrails, the fifth wheel hitch comprising a plurality of first engagement features each configured to matingly engage a respective one of a plurality of second engagement features formed in the bedrails, and wherein rotational movement of the handle in the second direction causes the cams to vertically lower the plate and the hitch such that the first engagement features are simultaneously vertically lowered into engagement with the second engagement features to secure the hitch to the bedrails.

15. The assembly of claim 1, wherein the at least one handle is rotatably coupled with the plate such that the at least one handle is rotatable relative to the plate.

16. The assembly of claim 15, wherein the plate is secured to the pivoting arm at a pivot point about which the pivoting arm is pivotable, and wherein the at least one handle and plurality of cams are rotatable relative to the plate and the pivoting arm.

17. The assembly of claim 16, wherein as the at least one handle is rotated, at least one of the plurality of cams is correspondingly rotated to push against the pivoting arm to cause the pivoting arm to pivot about the pivot point in a direction away from the plate to lift the plate.

18. A fifth wheel hitch cart assembly, comprising:
a plate;
a pivoting arm disposed between a rolling device and the plate, the pivoting arm being rotatably coupled to the plate at a pivot point;
at least one handle rotatably coupled with the plate; and
a plurality of cams operably coupled with the at least one handle and disposed between the plate and the pivoting arm such that rotational movement of the handle causes the cams to rotate relative to the pivoting arm and push against the pivoting arm to cause the pivoting arm to pivot about the pivot point in a direction away from the plate to lift the plate relative to the pivoting arm.

19. A method for moving a hitch, comprising:
positioning a cart under a hitch, the cart comprising a plate, a rolling device, a pivoting arm disposed between the rolling device and the plate, at least one handle coupled with the plate, and a plurality of cams operable coupled with the at least one handle and disposed between the plate and the pivoting arm such that rotational movement of the handle in a first direction causes the cams to lift the plate and rotational movement of the handle in a second direction opposite the first direction causes the cams to lower the plate;
rotating the handles in the first direction to lift the plate and hitch;
moving the cart and hitch to a desired location; and
rotating the handles in the second direction to lower the plate and hitch.

20. The method of claim 19, wherein the desired location is a bed of a towing vehicle, the towing vehicle comprising bedrails, wherein the handles are rotated in the second direction to lower the hitch onto the bedrails.
